(19) United States
(12) Patent Application Publication
(10) Pub. No.: US 2012/0112642 A1
(43) Pub. Date: May 10, 2012

(54) ORGANIC ELECTROLUMINESCENT APPARATUS

(75) Inventor: Kouji Ikeda, Chiba-shi (JP)

(73) Assignee: CANON KABUSHIKI KAISHA, Tokyo (JP)

(21) Appl. No.: 13/381,221

(22) PCT Filed: Mar. 9, 2010
(86) PCT No.: PCT/JP2010/005425

§ 371 Date: Dec. 28, 2011

(30) Foreign Application Priority Data
Sep. 8, 2009 (JP) 2009-206730

(51) Int. Cl. H05B 37/00

(52) U.S. Cl. 315/161

(57) ABSTRACT

In a display apparatus, at least three light emitting elements included in each pixel are classified into a light emitting element(s) of which anode(s) is the common electrode and a light emitting element(s) of which cathode(s) is the common electrode. The combination of classification of at least three light emitting elements is a combination that minimizes a difference between the total value of current flowing, during an emission in the maximum luminance, in the light emitting element(s) of which anode(s) is the common electrode and the total value of current flowing, during an emission in the maximum luminance, in the light emitting element(s) of which cathode(s) is the common electrode.

### TECHNICAL FIELD

The present invention relates to an organic electroluminescent apparatus.

### BACKGROUND ART

Light emitting elements used for display apparatuses emitting a plurality of colors of light include light emitting elements disclosed in Japanese Patent Application Laid-Open No. 2005-174639 and U.S. Pat. No. 57,077,452.

In a multi-color light emitting element disclosed in Japanese Patent Application Laid-Open No. 2005-174639, stacking of organic luminescent layers increases the aperture ratio and extends the life. Here, application of an alternating current voltage to an electrode of a light emitting element to drive the light emitting element causes an upper layer of the light emitting element and a lower layer of the light emitting element to alternately emit light. In a multi-color light emitting element disclosed in U.S. Pat. No. 5,707,745, at least two light emitting elements are stacked, and separated by a transparent conductive layer in order to separately drive the elements. Since the electrode between the light emitting elements is common, the configuration is made such that power sources are connected in series. The power sources as many as the number of electrodes are required for the display apparatus.

### CITATION LIST

### Patent Literature

PTL 1: Japanese Patent Application Laid-Open No. 2005-174639

PTL 2: U.S. Pat. No. 5,707,745

### SUMMARY OF INVENTION

### Technical Problem

In the display apparatus of Japanese Patent Application Laid-Open No. 2005-174639, since the light emitting elements on the respective layers alternately emit light, the light is emitted for only 50% of the period at the maximum. Therefore, it is necessary to emit light with a luminance twice that thereof to acquire a desired luminance. This increases a drive current of the light emitting element. Accordingly, there is a method of causing light emitting elements to simultaneously emit light, instead of alternately causing the stacked elements to emit light. However, in this case, since the light emitting elements are typically connected in series, the drive current in the entire display apparatus is the sum of the drive currents of the light emitting elements. This offers a problem of requiring a current substantially identical to that in a case without stacking.

Drive currents of light emitting elements are typically different with respect to the colors. Accordingly, in the display apparatus of U.S. Pat. No. 5,707,745, a current flows through the transparent electrode sandwiched between the light emitting elements. The transparent electrode typically has a high electric resistance in comparison with an opaque electrode such as a metal. The potential of the transparent electrode varies when the current is flowing. As a result, with respect to certain display images, there arise problems of disturbing the white balance, varying the luminance and degrading the image quality.

It is an object of the present invention to provide a display apparatus that includes a configuration where light emitting elements are stacked (stacked light emitting element), suppresses variation in potential of a common electrode and enables an image to be displayed in favorable quality. Further, it is another object to provide a display apparatus that suppresses the amount of current supplied to the entire light emitting elements from a power source, allows the power source to be downsized and enables the power consumption to be reduced.

### Solution to Problem

In order to solve the above problem, the present invention provides a display apparatus comprising: a plurality of pixels , each pixel consists of including three or more light emitting elements, respectively having common electrodes set at a potential common to each other, wherein the three or more light emitting elements in each of the pixels are classified into two groups, one group including the light emitting element or elements of which anode are the common electrode, and the other group including the light emitting elements or element of which cathode is the common electrode, so as to minimize a difference between a total value of current flowing, during an emission in a maximum luminance, in the light emitting element or elements of which anode are the common electrode and a total value of currents flowing, during the emission in the maximum luminance, in the light emitting elements or element of which cathode is the common electrode.

### Advantageous Effects of Invention

The present invention allows variation in potential of a common electrode to be suppressed and enables an image to be displayed in favorable quality, in a configuration where light emitting elements are stacked. Further, the present invention suppresses the amount of current supplied to the entire light emitting elements from a power source, allows the power source to be downsized and enables the power consumption to be reduced.

Further features of the present invention will become apparent from the following description of exemplary embodiments with reference to the attached drawings.

### BRIEF DESCRIPTION OF DRAWINGS

[FIG. 1]

FIG. 1 is a diagram illustrating a connecting relationship of light emitting elements in a display apparatus of Example 1.

[FIG. 2]

FIG. 2 illustrates a sectional view of a principal part of the configuration of the light emitting elements in a display apparatus of Example 1.

[FIG. 3]

FIG. 3 is a diagram illustrating a relationship between the light emitting elements and drive currents thereof in Example 1.

[FIG. 4]

FIG. 4 is a diagram illustrating a relationship between luminance-current characteristics and the drive current of light emitting elements.

[FIG. 5A]

FIG. 5A is a diagram illustrating pixel circuits preferably used for the display apparatus of the present invention.

[FIG. 5B]

FIG. 5B is a diagram illustrating pixel circuits preferably used for the display apparatus of the present invention.

[FIG. 6]

FIG. 6 is a diagram illustrating a connecting relationship of light emitting elements in a display apparatus of Example 2.

[FIG. 7]

FIG. 7 is a sectional view of a principal part of the configuration of the light emitting elements in a display apparatus of Example 2.

[FIG. 8]

FIG. 8 is a diagram illustrating a relationship between the light emitting elements and drive currents thereof in Example 2.

### DESCRIPTION OF EMBODIMENTS

An embodiment of a display apparatus of the present invention will hereinafter be described with reference to the drawings.

Well-known or publicly-known techniques are applied to parts that are not shown or described in this description. Each of the embodiments, which will hereinafter be described, is one embodiment of the present invention; the present invention is not limited thereto.

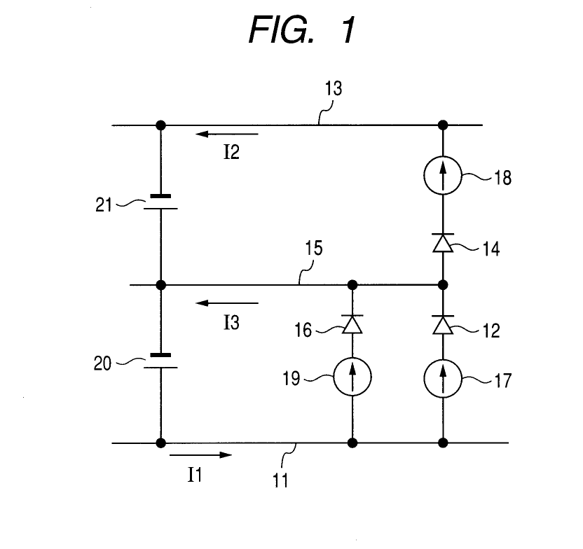

FIG. 1 is a diagram illustrating an electric connecting relationship per pixel of the display apparatus of the present invention. In FIG. 1, reference numeral 11 denotes a first power source wiring; reference numeral 12 denotes a first light emitting element; reference numeral 13 denotes a second power source wiring; reference numeral 14 denotes a second light emitting element; reference numeral 15 denotes a third power source wiring; reference numeral 16 denotes a third light emitting element. Reference numeral 17 denotes a first current control element; reference numeral 18 denotes a second current control element; reference numeral 19 denotes a third current control element; reference numeral 20 denotes a first power source voltage; reference numeral 21 denotes a second power source voltage. In FIG. 1, current sources are used as current control elements. The current sources control currents to be supplied to the respective light emitting elements.

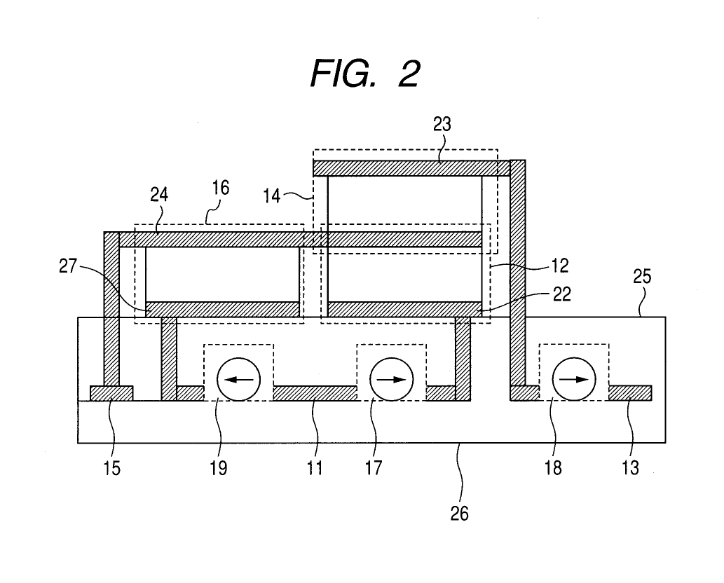

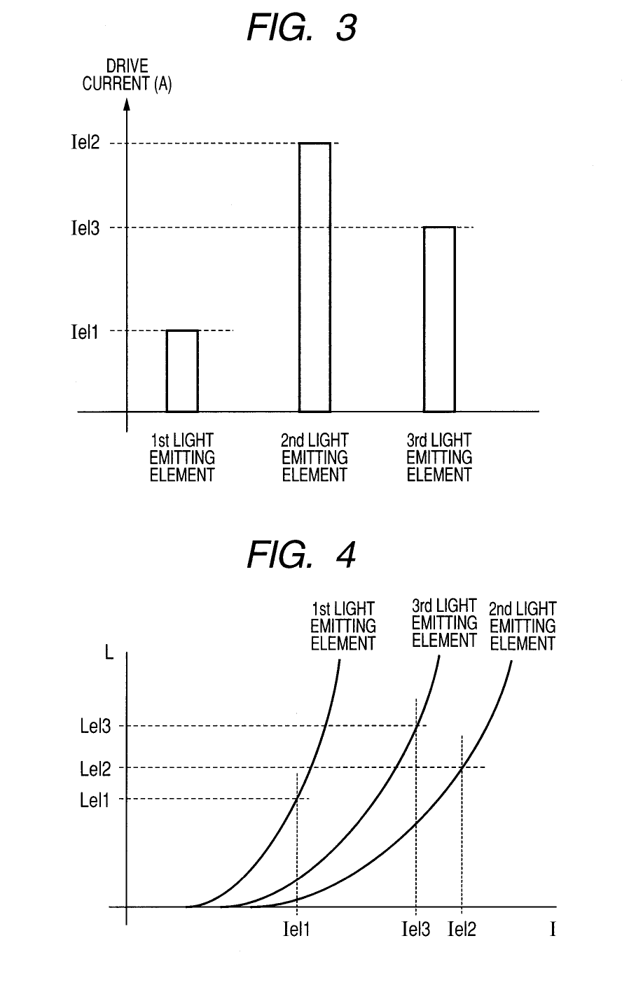

FIG. 2 illustrates a sectional view of a principal part of the configuration of the light emitting elements configuring FIG. 1. Element members identical to those of FIG. 1 are denoted by the identical symbols. Reference numerals 22, 23, 24 and 27 denote electrodes sandwiching the light emitting element. Reference numerals 22, 23 and 27 are pixel electrodes. Reference numeral 24 denotes a common electrode, which is connected to the third power source wiring 15. Reference numeral 25 denotes a protective insulation film. Reference numeral 26 denotes an insulating substrate. In FIG. 2, the anode 22 of the first light emitting element 12 is connected to the first current control element 17, and the cathode of the element 12 is the common electrode 24. The cathode 23 of the second light emitting element 14 is connected to the second current control element 18, and the anode of the element 14 is the common electrode 24. The anode 27 of the third light emitting element 16 is connected to the third current control element 19, and the cathode of the element 16 is the common electrode 24. As described, the first to third light emitting elements are classified into the light emitting element(s) of which anode(s) is the common electrode and the light emitting element(s) of which cathode(s) is the common electrode 24. Here, the common electrodes mean electrodes of which potentials are equal to each other. FIG. 2 illustrates an example of the stacked light emitting elements where the cathode of the first light emitting element, the anode of the second light emitting element and the cathode of the third light emitting element are configured by continuous electrodes. However, this configuration offers no limitation. For example, even if the elements are not stacked light emitting elements but the electrodes thereof are separate electrodes, a configuration including common electrodes with a potential common to each other allows the power source necessary for the display apparatus to be downsized and enables the power consumption to be reduced, thereby allowing the advantageous effects of the present invention to be exerted. Further, the first to third light emitting elements emit light, for example, by drive currents illustrated in FIG. 3. One of two electrodes of each light emitting element is mutually connected, thereby configuring the common electrode 24. The plurality of pixels are arranged so as to mutually connect the common electrodes 24.

According to the present invention, at least three light emitting elements are arranged so as to minimize a difference between a total value of current flowing, during an emission in the maximum luminance, in the light emitting element of which anode is the common electrode and a total value of current flowing, during an emission in the maximum luminance, in the light emitting element of which cathode is the common electrode. Minimization of the difference between the total values suppresses variation in potential of the common electrode, thereby enabling an image to be displayed in favorable quality. Note that one pixel includes at least one light emitting element of which anode is connected to the common electrode and at least one light emitting element of which cathode is connected to the common electrode, and the total number of light emitting elements is at least three. Further, an organic electroluminescent element, where electrodes sandwich an organic compound layer at least including a light emitting layer and a voltage is applied between the electrodes and which thereby causes the light emitting layer to emit light, may be used as the light emitting element. The light emitting element is not limited to the organic electroluminescent element. Instead, the present invention can be applied even to an inorganic electroluminescent element, only if the element is a spontaneously light emitting element, which emits light by applying voltage or current.

Typically, a light emitting element that emits light corresponding to red, blue or green can be used as the light emitting element of the present invention. A drive current defines which light emitting element corresponds to which color. The drive current varies according to materials configuring the light emitting element.

Here, drive currents of the light emitting elements in the display apparatus of the present invention can be drive currents of the respective light emitting elements when light emitted from the light emitting elements in each pixel are mixed to be white light. The amount of light emission necessary to create white light by emission of the light emitting elements is dependent on the respective chromaticities of the light emitting elements. The drive currents necessary to acquire the amount of light emission for the respective light emitting elements are dependent on light emitting efficiencies of the light emitting elements. This is because, in general, the largest current is necessary for the entire display apparatus when white light is being emitted.

As to the current control element of the present invention, for example, a switching element such as a TFT is connected to the light emitting element in series according to need of gradation displaying and the like and controls the drive current. Accordingly, the connecting arrangement may be inverted, only if the current control element and the light emitting element are connected to each other in series. In FIG. 1, the current sources control currents supplied to the respective light emitting elements. However, it is not necessary to use the current sources.

In the present invention, the voltage supplied to third power source wiring can be between the voltage supplied to the first power source wiring and the voltage supplied to the second power source wiring. As a result, this enables the current flowing through the third power source wiring to be suppressed. Further, the voltage supplied to any one of the first to third power source wirings can be 0 V. Zero volts are often applied to a logic unit and another operation unit of the display apparatus. This is because the application negates the need to newly create a voltage and thereby allows the number of types of power source voltages supplied to the display apparatus to be reduced.

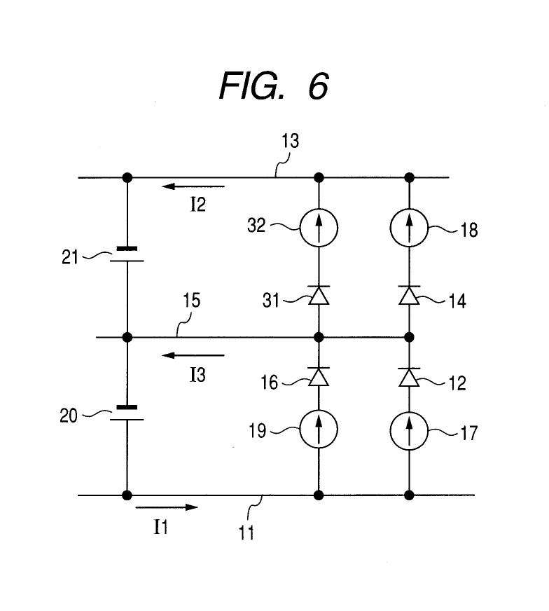

FIG. 1 illustrates the example of arranging three light emitting elements per pixel. The number of light emitting elements arranged in one pixel in the display apparatus of the present invention is not limited to three. For example, as illustrated in FIG. 6, four pairs of the light emitting element and the current control element may be arranged per pixel instead.

Next, a method of controlling the drive current will be described.

In the display apparatus of the present invention, the method of controlling the drive current of the light emitting element not only varies the amount of current in an analog manner, but also may control the current by regarding the current control element, such as the current source, as a switch to switch on/off. Further, if the current control element is connected to the light emitting element where the current is determined according to a voltage to be applied to the light emitting element, the current control element may be an element where variation in voltage applied to the light emitting element controls the current according to V-I characteristics of the light emitting element as a result.

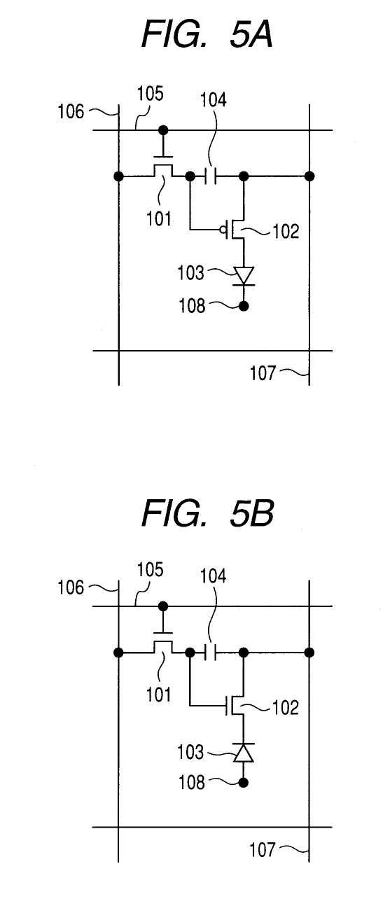

An example of controlling the drive current will be described using FIGS. 5A and 5B. FIGS. 5A and 5B illustrate the example of a TFT pixel circuit for controlling the drive current. The pixel circuit for controlling each light emitting element includes a switching TFT 101, a drive TFT 102, an organic electroluminescent element 103 and a capacitor 104.

FIG. 5A illustrates an example of a pixel circuit driving the first and third light emitting elements. FIG. 5B illustrates a pixel circuit driving the second light emitting element. In FIGS. 5A and 5B, a gate electrode of the switching TFT 101 is connected to a gate signal line 105. A source region of the switching TFT 101 is connected to a source signal line 106, and a drain region is connected to a gate electrode of the drive TFT 102. A source region of the drive TFT 102 is connected to the power supplying line 107, and the drain region is connected to a pixel electrode, which is one electrode of an organic electroluminescent element 103. The other electrode of the organic electroluminescent element 103 is connected to a counter electrode 108 and, in a case of FIG. 1, connected to the third power source wiring 15. A capacitor 104 is arranged such that respective electrodes thereof connects to the gate electrode of the drive TFT 102, and a source electrode and a power supplying line 107. The drive TFT 102 and the organic electroluminescent element 103 are thus connected to each other in series. The current flowing through the organic electroluminescent element 103 is controlled by the drive TFT 102.

The present invention has the connection capable of causing the light emitting elements to simultaneously emit light. However, the connection can be applied to a driving method that emits light in a time division manner with respect to each light emitting element.

### EXAMPLE

An example of the display apparatus of the present invention will hereinafter be described.

### Example 1

FIG. 1 is a diagram illustrating a connecting relationship per a pixel in the display apparatus of this example. The element members and the like are as described above.

In the display apparatus in FIG. 1, a difference can be minimized between the total value of the current causing the first light emitting element 12 and the third light emitting element 16 to emit light at the maximum luminance and the current causing the second light emitting element 14 to emit light at the maximum luminance. The first to third light emitting elements are determined in consideration of a large-small relationship of the drive currents of the light emitting elements. Each of the first to third light emitting elements may be any element material. For example, the first light emitting element may be red, the second light emitting element may be blue and the third light emitting element may be green.

FIG. 3 illustrates the drive currents of the respective light emitting elements in this example. Provided that the drive current of the first light emitting element is Iel1, the drive current of the second light emitting element is Iel2 and the drive current of the third light emitting element is Iel3, the large-small relationship of the drive currents is

Iel2>Iel3>Iel1.

Further, the drive currents of this example can be those of the respective light emitting elements when light emitted from the first to third light emitting elements are mixed to be white light. FIG. 4 illustrates an example of I-L characteristics of the light emitting elements of the display apparatus in FIG. 1. Provided that amounts of light emission necessary for the first to third light emitting elements to generate white light are Lel1, Lel2 and Lel3, the necessary drive currents are Iel1, Iel2 and Lel3, respectively.

In FIG. 1, I1 is a sum of currents necessary to drive the first and third light emitting elements, and capable of driving the first and third light emitting elements if I1=Iel1+Iel3. I2 is a current necessary to drive the second light emitting element, and I2=Iel2. The current I3 flowing through the third power source wiring is I3=I1−I2.

It is an object of the present invention to minimize the difference between the total value of current flowing, during an emission in the maximum luminance, in the light emitting element of which anode is the common electrode and the total value of current flowing, during an emission in the maximum luminance, in the light emitting element of which cathode is the common electrode. In order to realize that, it is necessary to connect the second light emitting element, whose drive current is the largest, to another light emitting element in series. Here, the difference between the total values is Iel1+Iel3−Iel2. If the light emitting elements other than the second light emitting element are connected to another light emitting elements in series, in a case where the first light emitting element is connected to another light emitting element in series, the difference between the total values is Iel2+Iel3−Iel1. In a case where the third light emitting element is connected to another light emitting element in series, the difference is Iel1+Iel2−Iel3. In cases of such connections, according to the large-small relationship of the drive currents illustrated in FIG. 3, the difference between the total values inevitably becomes larger than a case where the second light emitting element is connected to another light emitting element in series. Accordingly, the second light emitting element, whose drive current is the largest, is connected to another light emitting element in series. This configuration minimizes the difference between the total values. As a result, this suppresses the variation in potential of the common electrode, thereby enabling an image to be displayed in favorable quality.

Connection of second light emitting element, whose drive current is the largest, to another light emitting element in series also minimizes the maximum current supplied from the power source. Here, the maximum current supplied from the power source is the larger one of Iel1+Iel3 and Ie12. If the light emitting element other than the second light emitting element is connected to another light emitting element in series, in a case where the first light emitting element is connected to another light emitting element in series, the maximum current supplied from the power source is Iel2+Iel3. In a case where the third light emitting element is connected to another light emitting element in series, the current is Iel2+Iel1. In cases of these connections, according to the large-small relationship of the drive current illustrated in FIG. 3, the maximum current supplied from the power source inevitably becomes larger than a case where the second light emitting element is connected to another light emitting element. Therefore, connection of the second light emitting element, whose drive current is the largest, to another light emitting element in series minimizes the maximum current supplied from the power source. As a result, this allows the power source to be downsized and enables the power consumption to be reduced.

### Example 2

FIG. 6 illustrates an electric connecting relationship per pixel of the display apparatus in this example. Element members identical to those in FIG. 1 are assigned with the identical symbols. Reference numeral 31 denotes a fourth light emitting element. Reference numeral 32 denotes a fourth current control element. In FIG. 6, current sources are used as the current control elements. The current sources control the currents supplied to the respective light emitting elements.

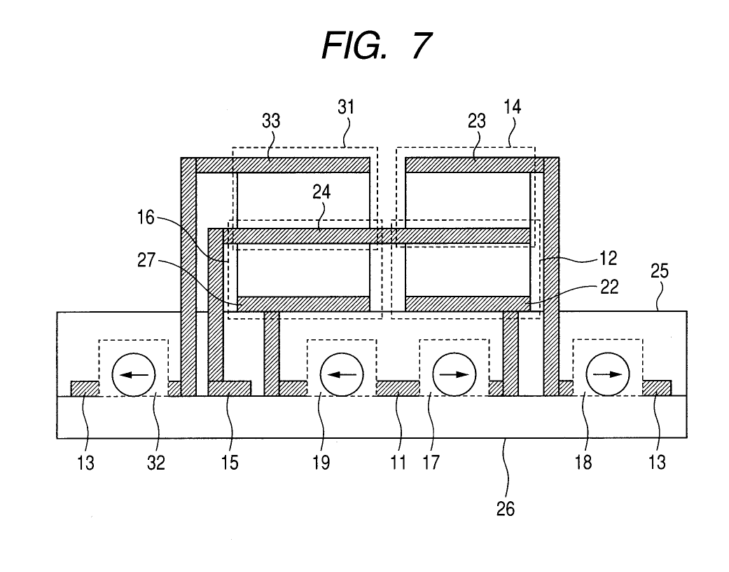

FIG. 7 illustrates a sectional view of a principal part of the configuration of the light emitting elements of the configuration in FIG. 6. Element members identical to those in FIG. 6 are assigned with the identical symbols. Reference numerals 22, 23, 24, 27 and 33 denote electrodes sandwiching the light emitting element; reference numerals 22, 23, 27 and 33 are pixel electrodes. Reference numeral 24 denotes a common electrode, which is connected to a third power source wiring 15. Reference numeral 25 denotes a protective insulation film; reference numeral 26 denotes an insulating substrate. In FIG. 7, the configuration is similar to that in FIG. 2, except that the fourth light emitting element 31 is connected to the second light emitting element in parallel. The cathode 33 of the fourth light emitting element 31 is connected to the fourth current control element 32. The anode of the element 31 is the common electrode 24. The first to fourth light emitting elements are thus classified into the light emitting element(s) of which anode(s) is connected to the common electrode 24 and the light emitting element(s) of which cathode(s) is connected to the common electrode 24. One of the two electrodes of each light emitting element is mutually connected, thereby configuring the common electrode 24. The plurality of pixels are arranged so as to mutually connect the common electrodes 24.

In the display apparatus in FIG. 6, the difference can be minimized between a total value of current for causing the first light emitting element 12 and third light emitting element 16 to emit light at the maximum luminance and a total value of current for causing the second light emitting element 14 and the fourth light emitting element 31 to emit light at the maximum luminance. The first to fourth light emitting elements are determined in consideration of a large-small relationship of the drive currents of the light emitting elements. The fourth light emitting element may have another color, for example, white, light blue, deep red or light green, or the same color as that of any one of the first to third light emitting elements. In consideration of simplifying a production process, the fourth light emitting element can have the same color as that of the second light emitting element. Further, the drive currents in this example can be the drive currents of the first to fourth light emitting elements when the light emitted from the same light emitting elements are mixed to be white light.

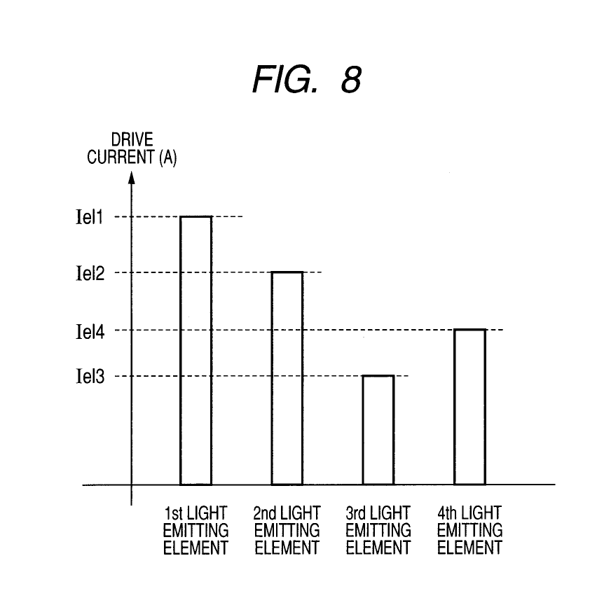

FIG. 8 illustrates the drive currents of the respective light emitting elements in this example. Provided that the drive current of the first light emitting element is Iel1, the drive current of the second light emitting element is Iel2, the drive current of the third light emitting element is Iel3 and the drive current of the forth light emitting element is Iel4, the large-small relationship of the drive currents is

Iel1>Iel2>Iel4>Iel3.

If the fourth light emitting element has the same color as that of the second light emitting element, the relationship may be

Iel4=Iel2.

In FIG. 6, I1 is the sum of currents necessary to drive the first and third light emitting elements. If I1=Iel1+Iel3, the currents are capable of driving the first and third light emitting elements. is a current necessary to drive the second and fourth light emitting elements. The relationship is I2=Iel2+Iel4. A current I3 flowing through the third power source wiring is I3=I1−I2.

It is an object of the present invention to minimize the difference between the total value of current flowing, during an emission in the maximum luminance, in the light emitting element of which anode is the common electrode and the total value of current flowing, during an emission in the maximum luminance, in the light emitting element of which cathode is the common electrode. In order to realize this, it is necessary to connect in series a parallel connection of the first light emitting element with the largest drive current and the third light emitting element with the smallest drive current and a parallel connection of other two light emitting elements. Here, the difference between the total values are Iel1+Iel3−Iel2−Iel4. If an element other than the third light emitting element is connected to the first light emitting element in parallel, in a case where the first and the second light emitting elements are connected in parallel, the difference between the total values is Iel1+Iel2−Iel3−Iel4. On the other hand, in a case where the first and fourth light emitting elements are connected in parallel, the difference is Iel1+Iel4−Iel2−Iel3. In cases of these connections, according to the large-small relationship of the drive currents illustrated in FIG. 8, the difference between the total values inevitably becomes larger than that in the case where the first and third light emitting elements are connected in parallel. Therefore, the first light emitting element with the largest drive current and the third light emitting element with the smallest drive current are connected in parallel. This connection minimizes the difference between the total values. As a result, this suppresses variation in potential of the common electrode, thereby allowing an image to be displayed in favorable quality.

Further, parallel connection of the first light emitting element with the largest drive current and the third light emitting element minimizes the maximum current supplied from the power source. Here, the maximum current supplied from the power source is the larger one of Iel1+Iel3 and Iel2+Iel4. If an element other than the third light emitting element is connected to the first light emitting element in parallel, in a case where the first and the second light emitting elements are connected in parallel, the maximum current supplied from the power source is Iel1+Iel2. In a case where the first and fourth light emitting elements are connected in parallel, the maximum current is Iel1+Iel4. In cases of these connections, according to the large-small relationship of the drive currents illustrated in FIG. 8, the maximum current supplied inevitably becomes larger than that in the case where the first and third light emitting elements are connected in parallel. Therefore, the first light emitting element with the largest drive current and the third light emitting element with the smallest drive current are connected in parallel. This connection minimizes the maximum current supplied from the power source. As a result, this allows the power source to be downsized and enables the power consumption to be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-206730, filed Sep. 8, 2009, which is hereby incorporated by reference herein in its entirety.

1. A display apparatus comprising:
a plurality of pixels,
wherein each pixel includes three or more light emitting elements, respectively having common electrodes set at a potential common to each other, the each pixel includes current sources each corresponding to each of the light emitting elements, and the current source controls current to be supplied to the light emitting element, and
wherein the three or more light emitting elements in each of the pixels are classified into two groups, one group including the light emitting element or elements of which anode are the common electrode, the other group including the light emitting elements or element of which cathode is the common electrode, the light emitting element or elements included in the one group are connected to a first power source voltage, and the light emitting element or elements included in the other group are connected to a second power source voltage, so as to minimize a difference between a total value of current flowing, during an emission in a maximum luminance, in the light emitting element or elements of which anode are the common electrode and a total value of currents flowing, during the emission in the maximum luminance, in the light emitting elements or element of which cathode is the common electrode.

2. The display apparatus according to claim 1, wherein
each of the pixels consists of first, second and third light emitting elements, and the currents flowing in the first, second and third light emitting elements, during the emission in the maximum luminance, are respectively I1>I2>I3, and
the one group includes the first light emitting element, and the other group includes the second and third light emitting element.

3. The display apparatus according to claim 1, wherein
each of the pixels consists of first, second, third and fourth light emitting elements, the currents flowing in the first, second, third and fourth light emitting elements, during the emission in the maximum luminance, are respectively I1>I2>I3>I4,
the one group includes first and fourth light emitting elements, and the other group includes the second and third light emitting elements.

4. The display apparatus according to claim 1, wherein the current source is connected to an electrode of the light emitting element opposite to the common electrode.
